(19) United States
(12) Patent Application Publication
(10) Pub. No.: US 2025/0315217 A1
(43) Pub. Date: Oct. 9, 2025

(54) System, Method and Computer Program Product for Efficiently Ensuring Accessibility Compliance of Software

(71) Applicant: User1st Ltd., Ramat Gan (IL)

(72) Inventors: Ben ROSANES, Bahan (IL); Ariel ORBACH, Ness Ziona (IL); Vladyslav NEMYROVSKI, Ramat Gan (IL); Anna DMYTRIV, Tel Aviv-Jaffa (IL)

(21) Appl. No.: 19/170,772

(22) Filed: Apr. 4, 2025

Related U.S. Application Data
(60) Provisional application No. 63/631,681, filed on Apr. 9, 2024.

(51) Int. Cl. G06F 8/30; G06F 8/61; G06F 8/71

(52) U.S. Cl. CPC G06F 8/30; G06F 8/61; G06F 8/71

(57) ABSTRACT

System for generating code, the system comprising software functionality which typically, e.g. once integrated with coder's code, modifies the coder's code to yield an accessible version of the coder's code; and/or an integration solution which integrates the software functionality with the coder's code.

### FIELD OF THIS DISCLOSURE

The present invention relates generally to software, and more particularly to achieving accessibility in software.

### BACKGROUND FOR THIS DISCLOSURE

The need for ensuring accessibility compliance and/or inclusivity of software products such as web or mobile applications, e.g., for users coping with disabilities, is well-known. Organizations are increasingly aware of the importance of creating digital experiences that cater to the needs of all users, including those with disabilities. Regulatory requirements further emphasize the need for accessibility.

The following approaches and strategies are now being employed to address the challenge of accessibility compliance and inclusivity:

Manual Accessibility Testing: organizations may rely on dedicated accessibility teams or external consultants to manually test their digital products for compliance with accessibility standards. This involves conducting thorough audits, using assistive technologies such as screen readers (JAWS, NVDA, Voiceover, Talkback etc.), Screen Magnifiers (Windows Magnifier, macOS Zoom), color contrast analyzers, keyboard navigation emulators, ARIA (Accessible Rich Internet Applications) accessibility validators, cognitive accessibility testing tools, and providing recommendations for improvements.

Automated Accessibility Testing: Automated tools and software such as AXE browser extension, Pa11y command-line tool, Google lighthouse, WebAIM WAVE etc. are available that analyze web pages or digital products for potential accessibility issues. These tools scan for accessibility issues in the coder's code, e.g., for violations of accessibility guidelines/regulations, e.g., WCAG, and provide reports with suggested fixes.

Training and Education: Organizations invest in training programs provided by, say, the International Association of Accessibility Professionals (IAAP), DEQUE University, The Paciello Group (TPG)-Accessibility Training, WebAIM, etc., to educate their development teams about accessibility best practices. This includes providing resources, workshops, and certifications to enhance developers' understanding of accessibility principles and techniques.

Collaboration with Accessibility Experts: Some organizations partner with accessibility experts or engage with accessibility communities such as to gain insights, guidance, and support in addressing accessibility challenges.

A conventional digital experience development platform (IDXDP) to assist users in development of digital applications is described here: patents.google.com/patent/U.S. Pat. No. 11,080,023B2/en?oq=U.S. Pat. No. 11,080,023.

Available solutions include:
A detection tool that is operated by a developer/QA engineer that works over the DOM/HTML/browser and web application, and in some cases can work as part of the IDE (integrated development environment).
3^{rd} party Overlay solution—that injects code on end user request, over the DOM/HTML/browser, operated manually or automatically or via AI analysis

The terms “accessibility requirements”, “demands”, “code standards”, and “regulations and/or standards that promote inclusivity” as used herein are each intended to include, by way of example, all or any subset of the WCAG standard guidelines/regulations.

The terms “accessibility” and “inclusivity” may be interchanged herein. “Accessibility” of software typically comprises software which is perceivable, operable, understandable, and robust, even for disabled persons.

Using website plugins to change a website's visual elements, is known.

ARIA aka Accessible Rich Internet Applications is a known set of attributes which may be added to HTML elements to yield web content and/or applications which are accessible, e.g., to users using assistive technologies (AT).

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate, e.g., as a software development Kit (SDK).

Certain embodiments of the present invention seek to provide a system which typically integrates with legacy and new coder's code and generates a (typically in-code) accessible version of the coder's code, typically without overlays, which confirms with suitable recommendations (e.g., WCAG) for making Web content accessible, e.g., for users with disabilities. The system typically automatically detects all or a subset of issues which render the coder's code inaccessible, and then automatically corrects or fixes all or a subset of issues detected.

Certain embodiments provide improved methods by which organizations which handle or generate software may ensure compliance with regulations and standards that promote inclusivity for individuals with disabilities.

Certain embodiments reduce or eliminate the need for code-operators to be familiar with the code standards, or to become familiar with these standards via training of all code-operators, e.g., employees and/or vendors.

Certain embodiments seek to provide a system for Intelligent Accessibility-Assistive Code generation which operates in conjunction with environments such as but not limited to Integrated Development Environments (IDEs) and Code Editors.

Certain embodiments seek to provide functionality for detection and correction of source code. The functionality may be implemented in software that is installed within the environment being used by a coder to develop the source code and assure compliance of the code with Web Content Accessibility Guidelines (WCAG).

The software may be activated (or run on the source code) while the coder is editing the source code before being processed. The software may be configured before being processed. The software may be activated after the code has been processed. The software may address wrapped code within the code. At least one software aspect (e.g., of the source code) may be edited or added to, e.g., edits such as change/s in the component/s and/or widget/s of the source code's user interface, change of color or style and/or additions (e.g., to the source code) such as added ARIA attributes, and added tab index attributes.

Certain embodiments seek to provide a processor component or software development Kit (SDK) that may be installed within an environment or user interface which a coder is using to develop source code, and which is configured to assure compliance of the source code with Web Content Accessibility Guidelines. The processor component may be activated while the coder is editing her or his source code and before the source code is processed. The processor component may be configured before the source code is processed. The processor component may be activated after the source code has been processed. The processor or the SDK component may address wrapped code within the source code. Typically, at least one aspect of the processed code is edited or added to, e.g., edits such as change in the components of the source code's user interface, change of color or style, and/or additions such as added ARIA attributes and added tabindex attributes.

It is appreciated that any reference herein to, or recitation of, an operation being performed, e.g., if the operation is performed at least partly in software, is intended to include both an embodiment where the operation is performed in its entirety by a server A, and also to include any type of “outsourcing” or “cloud” or “SDK” or “SaaS” or “Paas” or “PaaS” embodiments in which the operation, or portions thereof, is or are performed by a remote processor P (or several such), which may be deployed off-shore or “on a cloud”, and an output of the operation is then communicated to, e.g., over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A system for generating code, the system comprising software functionality which, once integrated with coder's code, modifies the coder's code to yield an accessible version of the coder's code; and/or an integration solution which integrates the software functionality with the coder's code.

Software herein may operate on any suitable hardware processor. the coder's code is typically developed within an environment used by the coder, such as an IDE or code editor. It is appreciated that any suitable integration solution may be employed, such as but not limited to by link, SDK, or code libraries that can be provided, say, by link/s or package/s e.g., NPM (Node Package Manager) package/s or dependency/ies which the coder may (e.g., as per documentation provided by the system) combine at or with the coder code. For example, the integration or injection solution by which the software (e.g. SDK) functionality is integrated with or injected into the coder's code may comprise adding to the coder's code at least one library (e.g. as may be described in the documentation) which stores code executing the software functionality (e.g., source code correction to achieve compliance according to embodiments of the invention). Code executing the software functionality may be installed, e.g., as a package, in the environment. Code executing the software functionality may reside in an SDK whose identity may be included in the documentation. The software functionality, once integrated with coder's code, provides an accessible version of the coder's code which, typically, is not an overlay solution (typically, the accessible version includes no overlays).

At least one code library may be copied and pasted from a flash drive or any other device. The terms “integration” and “injection” may be interchanged herewithin.

Embodiment 2. The system according to a preceding embodiment wherein the integration solution by which the software functionality is integrated with the coder's code comprises adding at least one link.

Typically, the documentation includes the link.

Embodiment 3. The system according to any of the preceding embodiments wherein the integration solution by which the software functionality is integrated with the coder's code comprises adding at least one library of code.

Typically, the documentation includes the library's location.

Embodiment 4. The system according to any of the preceding embodiments wherein the coder's code is being developed in an environment and wherein the integration solution by which the software functionality is integrated with the coder's code comprises installing at least one package in said environment.

Typically, the software functionality, or any code which effects source code modification, e.g., as the source code is being compiled, to achieve compliance of the source code according to embodiments of the invention, resides in the package.

Typically, the documentation indicates which packages to install.

Embodiment 5. A computer program product, comprising a non-transitory tangible computer readable medium having computer readable program code embodied therein, said computer readable program code adapted to be executed to implement a method for generating code, the method comprising: providing software functionality which, once integrated with coder's code, modifies the coder's code to yield an accessible version of the coder's code; and/or providing an integration solution which integrates the software functionality with the coder's code.

Embodiment 6. The system according to any of the preceding embodiments wherein the coder's code comprises source code for a mobile phone app.

Embodiment 7. The system according to any of the preceding embodiments wherein the integration solution by which the software functionality is integrated with the coder's code comprises using an SDK in which the software functionality resides.

Typically, the documentation stipulates which SDK to use.

Embodiment 8. The system according to any of the preceding embodiments wherein the coder's code comprises source code for web application.

Embodiment 9. The system according to any of the preceding embodiments wherein the integration solution by which the software functionality is integrated with the coder's code comprises providing at least one code library. Typically, the documentation stipulates which code library to use.

Embodiment 10. The system according to any of the preceding embodiments wherein the at least one code library is provided through a link.

Typically, the documentation stipulates the link.

Embodiment 11. The system according to any of the preceding embodiments wherein the at least one code library is provided as an NPM package.

Embodiment 12. The system according to any of the preceding embodiments wherein the at least one code library is provided as a dependency.

Embodiment 13. The system according to any of the preceding embodiments wherein the at least one code library is copied and pasted from another device such as a flash drive.

Embodiment 14. The system according to any of the preceding embodiments wherein the coder's code which is not accessible does not comply with WCAG and wherein the accessible version of the coder's code complies with WCAG, yielding an accessible, WCAG compliant version of the coder's code.

Embodiment 15. The system according to any of the preceding embodiments wherein the software functionality addresses wrapped code within the coder's code.

Embodiment 16. The system according to any of the preceding embodiments wherein the software functionality modifies the coder's code by injecting additional code to the coder's code.

Embodiment 17. The system according to any of the preceding embodiments wherein said injecting takes place while the coder's code is being compiled.

Embodiment 18. The system according to any of the preceding embodiments wherein said injecting takes place as the coder's code transitions into production code.

Embodiment 19. A method for generating code, the method comprising: providing software functionality, which, once integrated with coder's code, modifies the coder's code to yield an accessible version of the coder's code; and/or providing an integration solution which integrates the software functionality with the coder's code.

Also provided, excluding signals, is a computer program comprising computer program code means for performing any of the methods shown and described herein when said program is run on at least one computer; and a computer program product, comprising a typically non-transitory computer-usable or-readable medium, e.g., non-transitory computer-usable or-readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes, or a general-purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display, e.g., on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMS, EPROMS, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g., BLE) or wired (e.g., USB)), or a computer program stored in memory/computer storage.

The term “process” as used above is intended to include any type of computation or manipulation or transformation of data represented as physical, e.g., electronic, phenomena which may occur or reside, e.g., within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features, and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general-purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities, e.g., within the computing system's registers and/or memories, and/or may be provided on-the-fly, into other data which may be similarly represented as physical quantities within the computing system's memories, registers or other such information storage, transmission or display devices, or may be provided to external factors, e.g., via a suitable data network. The term “computer” should be broadly construed to cover any kind of electronic device with data processing capabilities, including, by way of non-limiting example, personal computers, servers, embedded cores, computing systems, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may, for example, comprise at least one CPU, DSP, FPGA, or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage, e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s, e.g., as described herein, which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus, the term user interface or SDK or “UI” as used herein includes also the underlying logic which controls the data presented to the user, e.g., by the system display, and receives and processes and/or provides to other modules herein, data entered by a user, e.g., using her or his workstation/device.

### BRIEF DESCRIPTION OF THE DRAWINGS

Example embodiments are illustrated in the various drawings. Specifically:

FIG. 1 is a simplified block diagram illustration of an embodiment of the present invention (which pertains to a mobile client by way of example).

FIGS. 2-3 illustrate an example embodiment in which the non-compliant coder's code comprises source code for a mobile application; these may be provided stand-along or in combination with one another and/or with FIG. 1.

FIG. 4 is a table of ARIA attributes which is useful in accordance with certain embodiments.

FIGS. 5-6 illustrate an example embodiment in which the non-compliant coder's code comprises source code for a web application; these may be provided stand-alone or in combination.

Embodiments illustrated are only exemplary; in the block diagrams, arrows between modules may be implemented as APIs and any suitable technology may be used for interconnecting functional components or modules illustrated herein in a suitable sequence or order e.g., via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another module. Communication between modules may comply with any customized protocol or customized query language, or may comply with any conventional query language or protocol.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown. tables herein may include all or any subset of the fields and/or records and/or cells and/or rows and/or columns described.

Computational, functional, or logical components described and illustrated herein can be implemented in various forms, for example, as hardware circuits such as but not limited to custom VLSI circuits or gate arrays or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines, and programs, and may originate from several computer files which typically operate synergistically.

Each functionality or method herein may be implemented in software (e.g., for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device, and a suitable processing unit (e.g., hardware processor and/or SDK) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC, or DSP, or any suitable combination thereof.

Any hardware component mentioned herein may in fact include either one or more hardware devices e.g., chips, which may be co-located or remote from one another.

Any method described herein is intended to include within the scope of the embodiments of the present invention also any software or computer program performing all or any subset of the method's operations, including a mobile application, platform, or operating system, e.g., as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory, and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line; which is of any type or level or amount or category of volatility, differentiation, mutability, accessibility, addressability, capacity, performance and energy use; and which is based on any suitable technologies such as semiconductor, magnetic, optical, paper, and others.

### DETAILED DESCRIPTION OF CERTAIN EMBODIMENTS

The term “accessible” as used herein refers to code which conforms with suitable recommendations (e.g., WCAG) for making Web content accessible e.g., for users using assistive technologies (AT).

Organizations which handle or generate code may experience challenges as they struggle with achieving compliance and maintaining compliance given frequent updates to their coders' code (e.g., website source code or mobile app source code).

Certain embodiments herein provide a system for generating accessible code which does not utilize an overlay approach; instead, an in-code approach is used. Typically, the system herein resolves at least one inaccessibility issue in coder's code without utilizing any automated solution that injects JavaScript snippets (e.g., widget, app, plugin, toolbar) into a website and, instead, updates or modifies the coder's code (e.g., a website's or mobile app's source code). Thus, the system herein typically changes the coder's code to resolve at least one inaccessibility issue in the coder's code without utilizing either generic or tailor-made overlay solutions.

A system for generating code is now described; the system typically includes or is operative in conjunction with an interface or environment which receives coder's code which is not accessible; and/or software functionality which typically, once integrated with the coder's code, provides an accessible in-code solution, rather than an overlay solution, for the coder's code, yielding an accessible version of the coder's code. The software functionality typically changes the coder's code (e.g., website source code or mobile app source code) to resolve at least one inaccessibility issue (or some or all inaccessibility issues) in the coder's code. Inaccessibility issues, aka non-compliance issues, typically include aspects of code which fail to comply with accessibility regulations, e.g., the WCAG standard guidelines also termed herein “regulations”. Any suitable technology may be used to integrate the code implementing the software functionality, with the coder's code. To give one example, the code implementing the software functionality may be configured to generate code snippets, and to generate documentation or instructions which prompt the coder to copy these snippets, then go into his development framework, and paste them into his code at locations, within the code, which may be defined by the documentation or instructions. Many other technologies are possible e.g., as described in detail below.

The system of the present invention typically automatically provides all or any subset of the following in any suitable order, e.g., as shown:
A. Detection of non-compliance issues regarding which a coder's code fails to comply with accessibility regulations, e.g., WCAG
b. Compilation and/or run time process for the code injection
c. Correction or source-code correction recommendation for each detected issue.

The system of the present invention may automatically provide all or any subset of the following in any suitable order, e.g., as shown:
a. Compiled code compliance identification
b. Adding/changing/editing source code manually
c. Proposing solutions to make the compiled code accessible d. Correcting the source-code.

According to certain embodiments, a method for semi- or fully-automated detection and/or correction of non-accessible developer's code is deployed by a coder in an environment (such as but not limited to an Integrated-Development-Environment (i.e., IDE), Code-Editor or Content Management System (aka CMS) to yield code that complies with accessibility regulations or demands e.g., all or any subset of the WCAG standard guidelines.

CMS (Content Management Systems) may for example include all or any subset of the following: WordPress, Joomla, Drupal, Shopify, Magento, Wix, Squarespace, Blogger, Ghost, Weebly, TYPO3, PrestaShop, Concrete5, OpenCart, Umbraco, Sitecore, ExpressionEngine, MODX, SilverStripe, Craft CMS, Liferay.

IDE (Integrated Development Environment) and/or Code Editors may, for example, include or any all subset of the following: Android Studio, Xcode, Visual Studio Code (VS Code), IntelliJ IDEA, Eclipse, PyCharm, Sublime Text, Atom, Vim, NetBeans, Notepad++, WebStorm, Brackets, PHPStorm, Code::Blocks, RubyMine, Qt Creator, Komodo IDE, TextMate, Emacs.

Each IDE may include a play button which the developer can press when s/he finishes a development cycle or process cycle (write/compile/publish) on the code and would like to run the code to check its compliance with accessibility regulations. The system herein may provide a detect/correct/compile cycle; while an initial “detect” output may indicate that 17 issues have been detected in the coder's code, once these have been corrected in the coder's source code, and the code re-compiled, the “detect” output may indicate that less than 17 issues, e.g., zero issues, are detected.

Typically, responsive to the developer having pressed the play button, the IDE runs a compilation on the source code and replaces the source code with binary code which the IDE runs, executing the code for run time. Thus, the IDE's compilation engine may be used for analysis of source code, and/or for analysis of instructions given by the code-operator that has been planted or injected into the source code and/or for source code modification.

Typically, each time a code-related-person (aka code-operator or coder) such as a developer, programmer, engineer, designer, quality assurance person, or CMS manager, compiles her or his source code in an environment (aka development environment) such as an IDE or code editor or CMS, or outside the environment, thereby to yield compiled code, one or more of the following processes will occur:
1. (scan/detect) Identification of compliance of the compiled code with accessibility requirements e.g., all or any subset of the WCAG standard guidelines,
2. (semi-automated correction) Proposing solutions (e.g., modifications of the compiled code) to make the compiled code accessible
3. (semi-automated correction) Proposing solutions for correcting the source code (e.g., suggesting, to the coder aka code-operator, modifications of the source code) e.g., so that when the source code, as so corrected, is compiled, the compiled code will be accessible
4. (fully automated correction) Correcting the source code e.g., so that when the source code, as so corrected, is compiled, the compiled code will be accessible
5. (fully automated correction) Correcting the compiled code to make the compiled code, as corrected, accessible e.g., as defined by the accessibility requirements.

The decision on which process/es to perform may be made by the coder or by the system, or may be a (typically configurable) parameter. According to certain embodiments, the system performs only some or only one of the above processes.

It is appreciated that illustrated elements may or may not be provided in practice, depending on which work mode/s the system supports (only fully automated, only semi-automated, or both).

Some code editors and CMS (content management systems) use terms like “demo” or “edit mode” when referring to code compilation. Compilation as used herein is intended to include any program or code (aka “compilation engine”) that converts or translates code written in one programming language (source language) into another language (target language) such as but not limited to translating high-level programming languages or human-readable code into low-level languages, such as assembly or machine code, and yielding an executable program. Some CMSs and/or code editors may perform compilation using a code mode of pre production environments before the code/changes for production is published.

For example, WordPress provide three stages: Edit Page→Draft→Pending review/changes→Publish.

According to certain embodiments, while the code-operator is in the process of writing code, following the stage of code compilation, the code-operator becomes able to identify compliance with the accessibility requirements of the compiled code and/or solutions are proposed within the environment (CMS, IDE, code editor) for making the compiled code accessible, and/or solutions are proposed for correcting the source code and/or the source code and/or compiled code are actually corrected.

Typically, each time the code operator asks to have her or his code compiled (or on at least one such occasion), the compilation engine may use, for the analysis of the source code, an instruction given by the code-operator that has been planted or injected into the source code, or may use source code modification. Injecting code into the source-code (or integration of the accessibility regulation compliance correction code according to embodiments herein with the source code whose compliance is to be so assured) may be performed by code libraries provided according to certain embodiments, which may be set/installed on a developer IDE. The code libraries may, for example, effect injection using a dependency injection or a programming technique in which a first object or first function receives other objects or functions that the first object or first function depends on. It is appreciated that injection or integration can be accomplished using any suitable technology such as but not limited to: adding new code entity/ies (e.g., code attributes, code functions, code tags, generated code files) to the source code, and/or by removing or adjusting or modifying existing code entity/ies (e.g., code attributes, code functions, code tags, generated code files) from the source code.

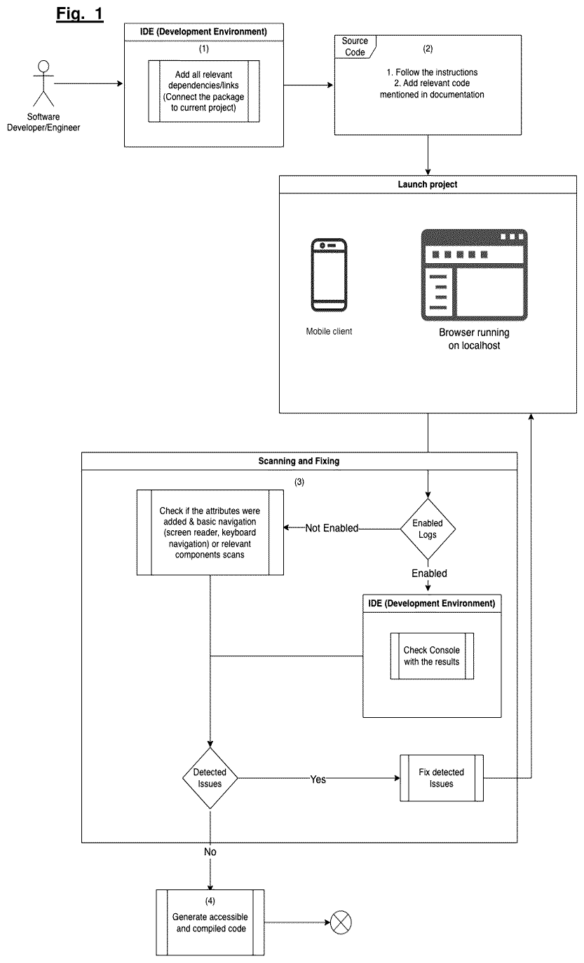

Reference is now made to FIG. 1 which illustrates an embodiment of the present invention; all or any subset of the illustrated blocks may be provided, in any suitable arrangement e.g., as shown.

In FIG. 1, the term localhost may refer to a loopback address typically with a default IP (e.g., 127.0.0.1) which a code operator may use to test programs or applications on her or his own computer, rather than sending information over the Internet. Whereas normally, when an IP address is called from a computer A, the effect is that some remote computer B is called via the Internet, when a loopback address is used, the effect is that the code operator's computer contacts the localhost, i.e., itself.

A method of operation or flow according to FIG. 1 may for example include all or any subset of the following operations, suitably ordered e.g., as shown (or as follows):

Operation 1: In IDE (Development Environment), dependencies/links may be added (to connect the package to current project so as to integrate source code being developed in the current project, whose accessibility compliance is to be assured, with code performing code compliance correction functionality described herein). Typically, a developer takes the code which performs the accessibility regulation compliance functionality of the present invention, and combines this code (e.g., integrates or injects) with the coder's source code whose compliance is to be assured.

It is appreciated that when a software application uses a library to query a database, the library may be considered a dependency. A dependency may be a single file or may be plural files and/or folders organized into packages. For example, if a mobile application uses an external package for encryption, this package and any libraries the package may call, are considered the app's dependencies. The libraries may also be deemed dependencies of the app's dependencies. Any unit of code (e.g., library or SDK) outside of the coder's code that the coder's code calls, is considered a dependency whose use typically enables savings on designing, writing, testing, debugging, and maintaining that unit of code vis-a-vis incorporating the functionality of the dependency into the source code itself.

Operation 2 (Source Code): Typically, suitable instructions/documentation are provided to e.g., displayed or otherwise presented to) the coder by the system, for any coder's code which may be built with components which may be deemed to require additions to the coder's code. The instructions/documentation may be termed integration instructions and may indicate to the coder how to inject the code according to an embodiment of the invention which assures compliance with accessibility regulations, into the coder's code (whose compliance is to be assured).

For example, if the coder's code is built with a “Menu” component, the system may require inserting “relevant code” into the coder's code e.g., a<U1menu>attribute, or other attribute, or a wrapper or tag into the coder's code to activate the correction injection.

Operation 2.5: Launch or publish project (e.g., source code whose compliance with accessibility regulation is to be assured), either on Mobile client or on Browser running on local host.

Operation 3-Scanning and fixing: As the developer compiles or runs the code, the system of the present invention may trigger scanning of the coder's code to detect accessibility issues therein.

According to certain embodiments, the system of the present invention is configured to provide logs to the developer, for use in software development of the coder's code. The logs typically indicate the problem and root cause for each accessibility issue in the coder's code.

It is appreciated that logs may or may not be enabled, as shown in FIG. 1. If the coder enables the log console, he/she will be provided with data and information relevant to solving the issue. Providing accessibility information as part of semi-automated embodiments of the invention facilitates the developer's understanding of the issue, and provides referral solutions e.g., by providing links to the WCAG (and/or other accessibility regulations) as well as best practices for implementation on each technology stack, for example Android documentation for Android, and Apple documentation for iOS.

If logs are not enabled, (e.g., if the coder does not enable the log console via the IDE) the coder or system herein typically checks if the attributes were added & basic navigation (screen reader, keyboard navigation) or relevant components scans (e.g., for detecting accessibility issues), emulating users of the coder's code who have accessibility issues, e.g., using the above tools: screen reader, keyboard navigation, facilitating verification that the injection was done correctly. If the logs are enabled, then in the IDE (Integrated Development Environment), console is checked (e.g., log console) with the results. Then, it is ensured that all detected accessibility issues have been resolved and that non-compliance issue detection functionality, which may be provided according to embodiments of the invention, is functioning properly. This semi-automated work mode may be performed by the coder typically according to guidelines (documentation) presented to the coder by the system of the present invention e.g., as described above.

Still with reference to FIG. 1, if issues are detected, detected issues may be fixed. For example, an Accordion component in the source code may be missing ARIA attributes, and, consequently, the screen reader may not be able to read the Accordion for disabled users of the coder's code. It is appreciated that in the art of user interfaces, an Accordion menu typically comprises a vertically stacked list of information items. For each list, a labelled header may be provided, which points to corresponding content. Each list's content may be hidden by default. An Accordion Menu may be built using, say, HTML, CSS, or JavaScript.

If no issues are detected, generate accessible and compiled code.

Thus, a system according to FIG. 1 typically comprises all or any subset of the following modules:

Module1: To perform the accessibility assessment process, at least one unique line of code, which performs source code correction functionality according to embodiments of the invention, is added or installed, e.g., manually by the coder, to the coder's code, and/or or least one unique file of code, which performs source code correction functionality according to embodiments of the invention, is added to the source code's library of files, so as to integrate functionality of embodiments of the present invention with the coder's code (e.g. source code of a website or mobile app or source code of any other software product which interfaces with users). It is appreciated that any suitable method may be employed to integrate source code modification functionality to achieve accessibility regulation compliance (e.g. WCAG compliance) as described herein with the coder's code, such as but not limited to adding a link, adding libraries of code, or installing packages.

For example, coders may be given all or any subset of the following three options: adding a link that pulls software functionality (e.g., correcting source code to achieve compliance with accessibility regulations according to embodiments of the invention) from the cloud, installing libraries storing software functionality according to embodiments of the invention, typically manually, or running a code package (e.g., in which software functionality (e.g., source code correction to achieve compliance) according to embodiments of the invention resides) and/or dependency/ies which store software functionality (e.g., source code correction to achieve compliance) according to embodiments of the invention on the coder's code.

Module2: The code operator manually or automatically configures the coder's aka code operator's source code, including adding at least one tag or attribute (which facilitates or performs source code correction functionality according to embodiments of the invention) to a line in the coder's code (e.g., website source code document), or above a section that performs as a widget or a component inside non-compliant code (e.g., a web app or mobile app, or website., or web-app). If there are several such sections, a tag/attribute is typically added above each.

Typically, tags and/or class attributes and/or reflection (e.g., as in reflective programming) and/or and)/wrapping (e.g., by using a wrapper function) (for tags/components/widgets) and/or code overriding (tags/components/widgets properties in runtime) and/or extensions (for Kotlin-Android/Swift-iOS) are added for each component, typically to include web and mobile.

Module3: On compilation, or on run time, or process of deployment, new code is added to the original compiled code. Typically, an ongoing scanning process detects accessibility issues over newly compiled or run time code changes.

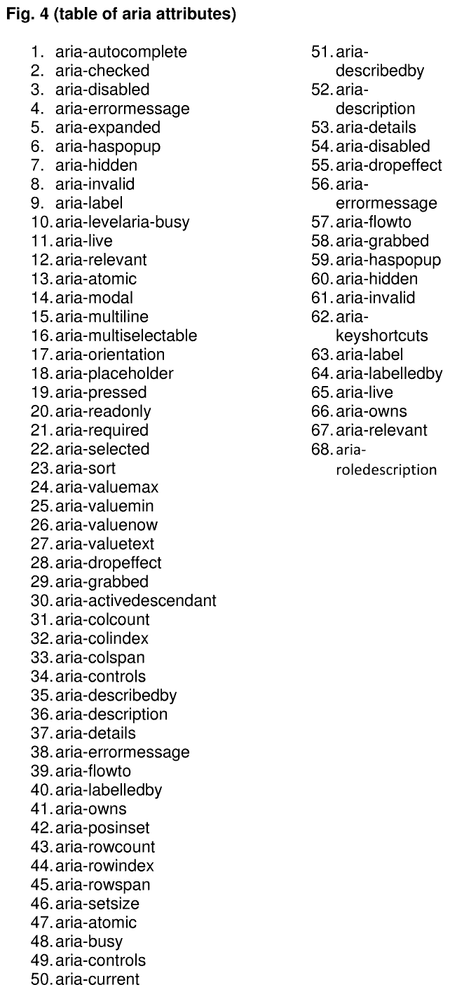

Module4: ARIA (Accessible Rich Internet Applications) attributes (e.g., any of the attributes appearing in FIG. 4) are added to the compiled code.

Once a link has been added, or once packages or libraries (e.g., in which software functionality [e.g., source code correction to achieve compliance] according to embodiments of the invention resides) have been added or installed, to integrate into the local IDE environment in which the source code whose compliance is to be assured, is being developed, some or all accessibility issues may be detected. Once the developer gets the report from this phase, he/she can, in semi-automatic mode, proceed, issue by issue, to add the tags/attributes to the relevant component so that the correction process can inject the correct missing code to the same component and change it from not accessible to accessible.

As described, in module 4, ARIA attributes are added to compiled code. Alternatively, or in addition, an original tag (e.g., in compiled code) may be changed to a different tag, e.g., as per the following tags list:
<div>
<a>
<input>
<select>
<option>
<h #>
<button>

Alternatively, or in addition, a mobile component (e.g., in compiled code) may be changed to a different mobile component e.g., as per the following component list:
Base
Colors
Icons
Fonts
Header
Button
Input
List
Tab
Card
Badge
Cover
Menu
Grid
Swiper
Page
Include
Popover
Alert
Toast
Loading
Timeline

| COMPONENTS | CHARTS |
|---|---|
| Chartist | |
| Progress | Circle |
| Progress | Semicircle |
| Chart Bar | |

Typically, the method includes all or any subset of the following stages a-c, which may be performed e.g., by a coder in any suitable order e.g., as follows:
a. Setup stage (setup)-setups the project (e.g., source code whose compliance with accessibility regulations is to be assured) according to documentation.
b. Configuration (setup)-configures the input of the code that is about to fix the accessibility issues.
c. Launch & Output (runtime)-launches the project, after setting up the previous stages, and afterwards receives an accessible product/code/web/UI/mobile application.

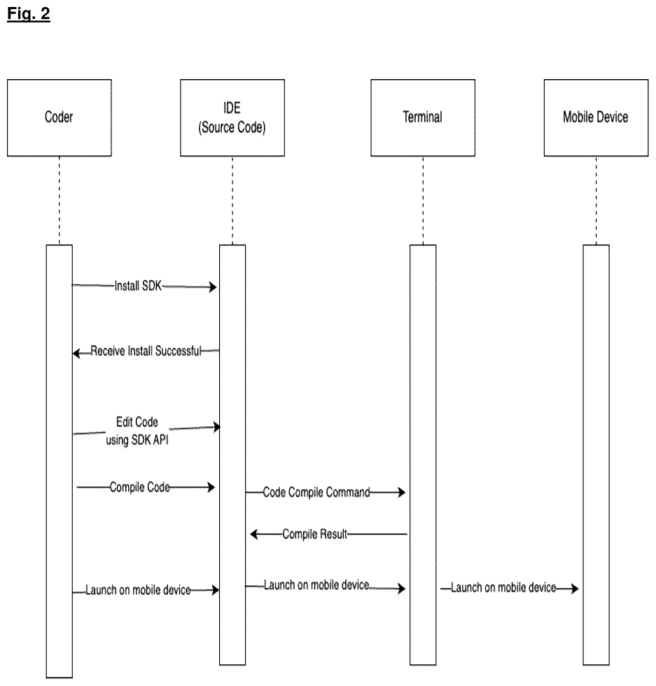

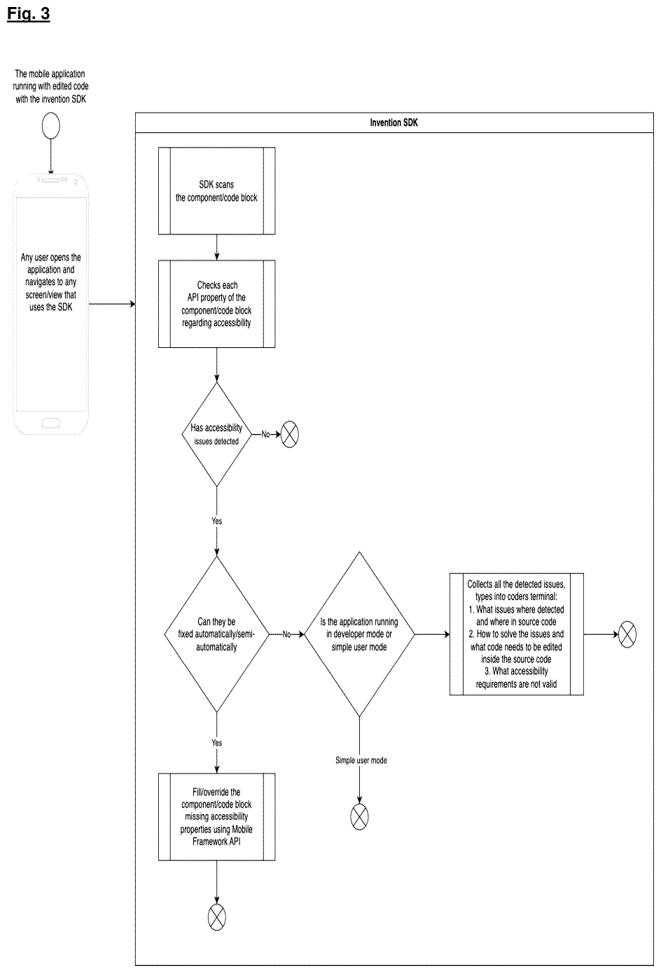

An example embodiment in which the non-compliant coder's code comprises source code for a mobile application is now described in detail with reference to FIGS. 2-3.

According to certain embodiments, a Software Development Kit (SDK) may be provided for coders (aka software engineers, software developers, programmers) who may use Integrated-Development-Environments (IDEs) or other Code Editors to detect and/or correct accessibility issues in a mobile application in accordance with accessibility regulations.

Whenever a coder writes code, performs maintenance, and/or edits source code for a mobile app (aka the coder's code herein), typically within an IDE, s/he may install or download the SDK (software development kit) shown and described herein, e.g., within the folder in which the mobile app's source code is stored, and may connect the dependencies between the source code and the SDK implementing the source code correction to assure compliance, e.g., as shown and described herein. The coder may scan (for accessibility issues) and may detect accessibility issues in the source code, either semi-automatically or automatically during run-time, while the mobile application is running, using the SDK's Application Programming Interface (API) over desired components or code blocks (e.g., according to the solution SDK documentation).

The coder may, for example, perform all or any subset of the following operations, in any suitable order, e.g., as shown:
1. Within the coder code (source code), install/download the SDK shown and described herein; and/or
2. Using the API of the SDK shown and described herein, edit the source code of the mobile application e.g., according to documentation or guidelines as provided.
3. Compile the source code as edited above with the tools provided by the IDE or commands within the command line of a terminal to yield, as final output, as file of format .apk, .abb, or .ipa (depending on whether the platform is Android or iOS).
4. Install the output file on a mobile device, running on Android or iOS, depending on the format of the output file, and publish (launch) the installed application with the edited coder code (source code).

Ultimately, the coder typically has an edited version of the code that will scan/detect and/or fix the accessibility problems in a semi-automatic or fully-automatic manner.

FIG. 2 is a sequence diagram illustrating Installation and usage of an SDK provided in accordance with certain embodiments.

Typically, the SDK, once installed and downloaded by the coder, and once the source code of the mobile app has been edited, triggers scanning functionality (for detecting accessibility issues, e.g.,) over connected components/code blocks by the developer via the SDK's API. The SDK reviews the accessibility demands and requirements and detects issues for the connected components/code blocks. The SDK's scanning/detection functionality may enhance components/code, may block accessibility properties, may make semi- or fully-automatic adjustments, and may print accessibility reports into the coder's terminal.

The sequence in FIG. 2 may, for example, include interactions between the following: Coder, IDE (where Source Code for a mobile app is being developed), Terminal (e.g., coder's work station), and Mobile Device (e.g., where mobile app is to run).

The sequence may include all or any subset of the following operations, suitably ordered, e.g., as shown:
Install SDK
Receive Install Successful
Edit Code using SDK API
Compile Code
Code Compile Command
Compile Result
Launch on Mobile Device.

FIG. 3 is an example of an operation flow for the SDK once the SDK has been installed. The mobile app's source code may be edited using the SDK API. The mobile application may be published or launched with the source code as edited.

The flow may include all or any subset of the following operations, suitably ordered, e.g., as shown:

The mobile application runs with mobile app source code (which may have been edited by the coder) and an SDK, in accordance with embodiments of the present invention, as shown. Any user may open the application and may navigate to any screen/view that uses the SDK.

SDK scans the component/code block.

SDK Checks each API property of the component/code block regarding accessibility.

End if no accessibility issues have been detected. Else, determine can issue/s be fixed automatically/semi-automatically. If not, determine whether the application is running in developer mode or simple user mode. End if in simple user mode.

Otherwise, SDK may collect all detected issues, and may (e.g., in semi-automatic work mode) present, e.g., display in coder's terminal:
1. Which issues were detected, typically including an indication of where in source code the issue/s were detected; and/or
2. How to solve the issues and what code needs to be edited inside the source code; and/or
3. Which accessibility requirements are not valid.

If issues can be fixed automatically/semi-automatically, the SDK may fill/override the component/code block missing accessibility properties, e.g., using Mobile Framework API.

The SDK may support Java/Kotlin and/or XML (for Android) and (for iOS) may support Swift and/or SwiftUI.

It is appreciated that any suitable technology may be employed to detect non-compliance/non-accessibility issues, e.g., in the embodiments of FIGS. 1 and 3. For example, the coder may be prompted by the system of the present invention to select an area on the screen (of a screenshot generated by the coder's source code) and the system of the present invention may be configured to identify, and to present to the developer, a list of all accessibility problems that exist within that area. To do this, the system of the present invention may include logic which provides tests for each of plural accessibility issues, where each test determines whether a particular accessibility issue is present in the coder-selected area.

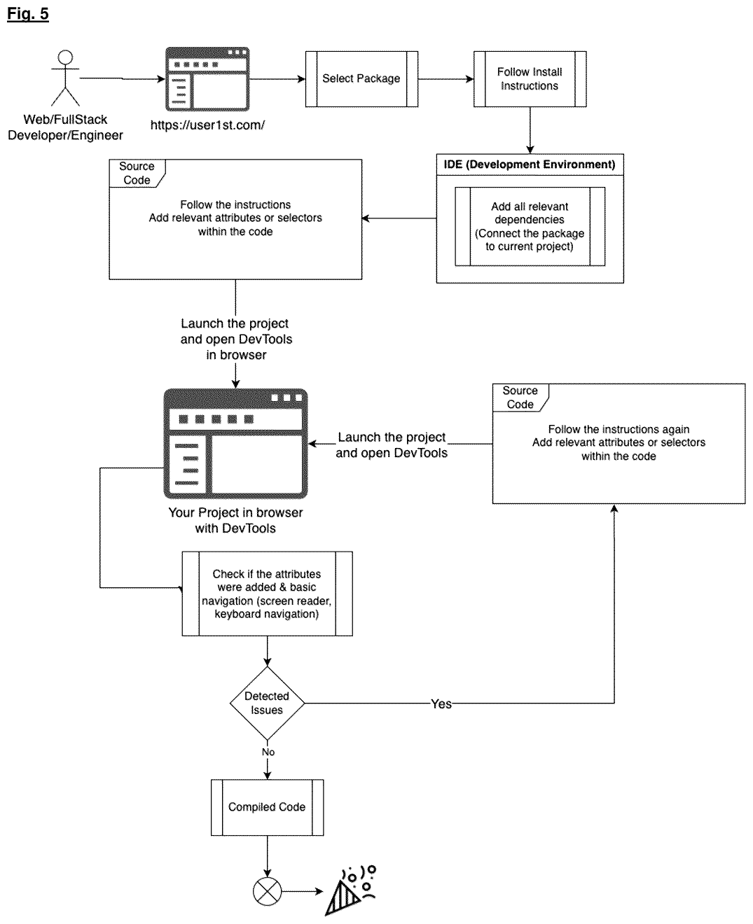

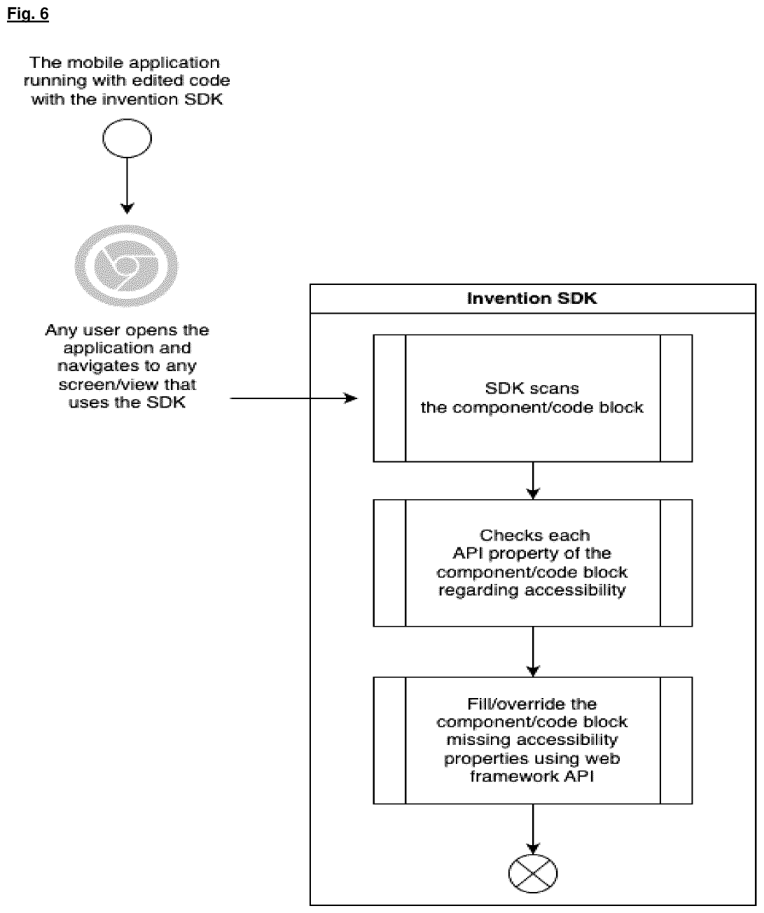

A second example embodiment in which the non-compliant coder's code comprises source code for a web application is now described in detail with reference to FIGS. 5-6.

Whenever a coder writes, performs maintenance on, and/or edits “coder's code” (e.g., source code) for a web application within an IDE, s/he may install or embed the solution SDK in the coder code (e.g., source code) for the web application, and may connect the dependencies between the coder code (e.g., source code) and the solution's SDK. A coder functionality typically scans or detects and/or fixes accessibility issues, whether semi-automatically or fully-automated, during run-time, while the web application is running, using the SDK's Application Programming Interface (API) over the desired components or code blocks, typically according to the solution's SDK documentation.

The coder may, for example perform all or any subset of the following operations, in any suitable order e.g., as shown:
1. Within the coder code (e.g., source code), install or embed the solution's SDK.
2. Using the API of the solution's SDK, edit the coder code (e.g., source code) of a web application according to documentation or guidelines as provided.
3. Optionally compile the edited coder code (e.g., source code) with commands within the command line of a terminal to obtain final output files of format .js, html, and/or .css.
4. Statically host the code (or dynamically deliver with a server), and visit the URL of the web application.

FIG. 5 is a sequence diagram showing an example flow covering both installation and usage; all or any subset of the illustrated components of the flow may be provided, suitably ordered e.g., as shown. Any suitable development environment (or code editor) may be employed by the coder, such as but not limited to VS Code.

The coder (e.g., Web/FullStack Developer/Engineer) may access a web service implementing the system of the present invention (represented in the drawing as “user1st.com”). A package may be selected and installation instructions may be followed. In the IDE (Development Environment) that the user is using to develop her or his code, all relevant dependencies are added, to connect the selected package to the coder's current project (to the coder's code for which accessibility compliance is sought to be achieved). Following instructions or documentation provided, relevant attributes or selectors may then be added within the coder's code (e.g., source code).

The user may then launch her or his project and may open DevTools (say) in the browser. The same instructions or documentation may be followed again with relevant attributes or selectors being added within the code.

It is appreciated that following a check to determine whether or not the attributes were added, and to check basic navigation (e.g., screen reader and/or keyboard navigation), the method may return to following instructions again, each time issues are detected, whereas as soon as no issues are detected, compiled accessible code results.

Thus, typically, once the coder has installed, e.g., embedded the SDK, and edits the coder code (source code), the solution SDK triggers scanning or detection of non-compliance issues over the components or code blocks which may be connected by the developer via its API. The scanning/detection functionality in the SDK enhances components/code, and/or blocks accessibility properties and/or makes semi-automatic or fully-automatic adjustments of the code to achieve compliance (e.g. with WCAG).

FIG. 6 depicts operation of a solution SDK, starting from the moment the web application is opened, according to certain embodiments. Typically, the mobile application under development may run with edited code with the solution SDK. A user may open the application and may navigate to any screen or view that uses the SDK. The solution SDK may then scan the component or code block. the SDK may check, from an accessibility viewpoint, at least one (typically each) API property of the component or code block. The SDK may then fill or override the component's or code block's missing accessibility properties e.g., using web framework API.

The solution SDK may be constructed using any suitable programming technique, such as but not limited to reflection, and typically supports plural Javascript (JS) frameworks and libraries, such as but not limited to all or any subset of: Vanilla JS, JQuery, Angular/AngularJS, React, Vue, Svelte. The SDK may for example support any JS-based framework. Suitable Java design patterns may be constructed using Singleton, Facade, Builder, or any other suitable programming technique.

Code that is compiled, which needs to comply with accessibility and/or inclusivity code standards, may be generated by (or have as a dependency) third party code, e.g., an external library, and since that code too needs to follow the code standards, any required adjustments need to be enforced on the source code of the library. Yet, absent embodiments herein, this task may be beyond the code-operator's skillset, e.g., because the code-operator needs to be familiar with the expected outcome of a compiled code.

Code-libraries which may be dependencies called by a given code operator's source code may for example include: React, Vue.js, Angular, Bootstrap, Material-UI, Tailwind CSS, Semantic UI, Foundation, Bulma, Ant Design, Chakra UI, PrimeReact, Vuetify, Quasar Framework, UlKit, Blueprint, Grommet, Carbon Design System, Semantic UI React, Onsen UI.

This makes the outcome result in significant time and resource investments, while achieving accessibility often falls short absent embodiments herein, particularly if a body of code calls dependencies which are non-compliant.

Also, approaches and strategies which are now being employed to address the challenge of accessibility compliance and inclusivity, may contribute to improving accessibility, but may not always be sufficient on their own. Automated tools may require manual verification but fully manual testing may be far more time-consuming and costly.

Also, some approaches to achieve accessibility compliance and inclusivity are difficult to use in practice; training programs take time to implement effectively, and collaboration with experts may require ongoing support.

Embodiments herein ensure a comprehensive and sustainable solution, and may combine the strengths of existing methods while addressing their limitations e.g., by incorporating accessibility principles into the development process and/or leveraging intelligent automation and/or utilizing advanced technologies to streamline the compliance process and/or to create an inclusive digital experience for all users.

Providing an in-code solution rather than an overlay solution is advantageous because websites may be updated frequently, and at each such update, any plugins are not necessarily updated.

The system herein may support accessibility for any type of disabilities, such as but not limited to all or any subset of the following disability categories: mental, visual, hearing, and motoric.

The system may ensure compliance with any suitable international standard, such as but not limited to WCAG.

Once accessibility compliance of a website or app's source code has been assured according to embodiments of the invention, there is no need for the website's interface to ask a user of the website for her or his disability type, which is an inadvisable option, even if legal, since there is a concern that a website page may change in a way that may block some of the services which cause discrimination. Embodiments herein typically do not require the end user to announce/select/click something in the interface which only then will become accessible to that user. Since the code is compiled once before push to production, the code is typically always accessible. Once a developer has wrapped his code with a tag according to any embodiment herein, the system herein (e.g., when compiling the code) fixes all wrapped tags, which greatly expedites and simplifies the coder's workload.

It is appreciated that many variations of the system herein are possible. For example, before coder's code is compiled or processed within a code infrastructure (e.g. IDE and or CMS) or on a programmer localhost, or in any development environment, detection of accessibility code violations may take place, including receiving a developer web page code or component widget code, or mobile application page code, automatically (partially or fully) enabling analysis and detection of accessibility issues of the code, and associating at least one code element or tag element within the page source code. The developer may be updated or alerted, and is then able to change the code according to system recommendations.

Alternatively or in addition, as the coder's code is compiled or processed typically within a code infrastructure (e.g., IDE and or CMS) or on a programmer localhost, or in any other development environment, the code is rendered accessible including receiving a developer web page code or component widget code (which may comprise code tag/s and/or tags' attributes and/or and widget functionality) and adding tags and/or attributes and/or functionality, e.g., as above, to an output of the compiled code, which can be used for (say) mobile application page code, and may be added automatically (fully or partially).

It is appreciated that web apps may be characterized by properties and/or tags and/or attributes; mobile apps may be characterized by widgets and/or components and/or views.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order, i.e., not necessarily as shown, including performing various operations in parallel or concurrently, rather than sequentially, as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices, each including at least one processor and/or cooperating input device and/or output device and operative to perform, e.g., in software, any operations shown and described herein; information storage devices or physical records, such as disks or hard drives, causing at least one computer or other device to be configured so as to carry out any or all of the operations of any of the methods shown and described herein, in any suitable order; at least one program pre-stored, e.g., in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented, e.g., by one or more processors. The invention shown and described herein may include (a) using a computerized method to identify a solution to any of the problems or for any of the objectives described herein, the solution optionally including at least one of a decision, an action, a product, a service, or any other information described herein that impacts, in a positive manner, a problem or objectives described herein; and (b) outputting the solution.

The system may, if desired, be implemented as a network, e.g., web-based system employing software, computers, routers, and telecommunications equipment, as appropriate.

Any suitable deployment may be employed to provide functionalities, e.g., software functionalities shown and described herein. For example, a server may store certain applications, for download to clients, which are executed at the client side, the server side serving only as a storehouse. Any or all functionalities, e.g., software functionalities shown and described herein, may be deployed in a cloud environment. Clients, e.g., mobile communication devices such as smartphones, may be operatively associated with, but external to the cloud.

The scope of the present invention is not limited to structures and functions specifically described herein, and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis, e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware, or software module, which is known or which is described herein to have capabilities to perform a technical operation responsive to the state or condition. The technical operation may for example comprise changing the state or condition, or may, more generally, cause any outcome which is technically advantageous given the state or condition or data, and/or may prevent at least one outcome which is disadvantageous given the state or condition or data. Alternatively, or in addition, an alert may be provided to an appropriate human operator or to an appropriate external system.

Features of the present invention, including operations which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order, may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered, e.g., as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof, can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g., wired data communication and/or in short-range radio communication with sensors such as cameras e.g., via Wifi, Bluetooth, or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile, e.g., laptop or other computer terminal, embedded remote unit, which may either be networked itself (may itself be a node in a conventional communication network, e.g.,) or may be conventionally tethered to a networked device (to a device which is a node in a conventional communication network or is tethered directly or indirectly/ultimately to such a node).

Any operation or characteristic described herein may be performed by another actor outside the scope of the patent application, and the description is intended to include apparatus, whether hardware, firmware, or software which is configured to perform, enable, or facilitate that operation or to enable, facilitate, or provide that characteristic.

The terms processor or controller or module or logic as used herein are intended to include hardware such as computer microprocessors or hardware processors, which typically have digital memory and processing capacity, such as those available from, say, Intel and Advanced Micro Devices (AMD). Any operation or functionality or computation or logic described herein may be implemented entirely or in any part on any suitable circuitry, including any such computer microprocessor/s as well as in firmware or in hardware, or any combination thereof.

It is appreciated that elements illustrated in more than one drawing, and/or elements in the written description, may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations, or functionalities described herein, which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations, or functionalities described herein, which are, for brevity, described in the context of a single embodiment, may also be provided separately or in any suitable sub-combination, including with features known in the art. Each element, e.g., operation described herein, may have all characteristics and attributes described or illustrated herein, or, according to other embodiments, may have any subset of the characteristics or attributes described herein.

It is appreciated that apps referred to herein may include a mobile app, computer app, or any other application software. Any application may be bundled with a computer and its system software, or published separately. The term “phone” and similar used herein is not intended to be limiting, and may be replaced or augmented by any device having a processor, such as but not limited to a mobile telephone, or also set-top-box, TV, remote desktop computer, game console, tablet, mobile, e.g., laptop or other computer terminal, embedded remote unit, which may either be networked itself (may itself be a node in a conventional communication network, e.g.,) or may be conventionally tethered to a networked device (to a device which is a node in a conventional communication network or is tethered directly or indirectly/ultimately to such a node). Thus, the computing device may even be disconnected from e.g., Wifi, Bluetooth, etc. but may be tethered directly or ultimately to a networked device.

References herein to “said (or the) element x” having certain (e.g., functional or relational) limitations/characteristics, are not intended to imply that a single instance of element x is necessarily characterized by all the limitations/characteristics. Instead, “said (or the) element x” having certain (e.g., functional or relational) limitations/characteristics, is intended to include both (a) an embodiment in which a single instance of element x is characterized by all of the limitations/characteristics and (b) embodiments in which plural instances of element x are provided, and each of the limitations/characteristics is satisfied by at least one instance of element x, but no single instance of element x satisfies all limitations/characteristics. For example, each time L limitations/characteristics are ascribed to “said” or “the” element X in the specification or claims (e.g. to “said processor” or “the processor”), this is intended to include an embodiment in which L instances of element X are provided, which respectively satisfy the L limitations/characteristics, each of the L instances of element X satisfying an individual one of the L limitations/characteristics. The plural instances of element x need not be identical. For example, if element x is a hardware processor, there may be different instances of x, each programmed for different functions and/or having different hardware configurations (e.g., there may be 3 instances of x: two Intel processors of different models, and one AMD processor).

1. A system for generating code, the system comprising:
software functionality which, once integrated with coder's code, modifies the coder's code to yield an accessible version of the coder's code; and
an integration solution which integrates the software functionality with the coder's code.

2. The system of claim 1 wherein the integration solution by which the software functionality is integrated with the coder's code comprises adding at least one link.

3. The system of claim 1 wherein the integration solution by which the software functionality is integrated with the coder's code comprises adding at least one library of code.

4. The system of claim 1 wherein the coder's code is developed in an environment and wherein the integration solution by which the software functionality is integrated with the coder's code comprises installing at least one package in said environment.

5. A computer program product, comprising a non-transitory tangible computer readable medium having computer readable program code embodied therein, said computer readable program code adapted to be executed to implement a method for generating code, the method comprising:
providing software functionality, which, once integrated with coder's code, modifies the coder's code to yield an accessible version of the coder's code; and
providing an integration solution which integrates the software functionality with the coder's code.

6. The system of claim 1 wherein the coder's code comprises source code for a mobile phone app.

7. The system of claim 6 wherein the integration solution by which the software functionality is integrated with the coder's code comprises using an SDK in which the software functionality resides.

8. The system of claim 1 wherein the coder's code comprises source code for web application.

9. The system of claim 8 wherein the integration solution by which the software functionality is integrated with the coder's code comprises providing at least one code library.

10. The system of claim 9 wherein the at least one code library is provided through a link.

11. The system of claim 9 wherein the at least one code library is provided as an NPM package.

12. The system of claim 9 wherein the at least one code library is provided as a dependency.

13. The system of claim 9 wherein the at least one code library is copied and pasted from another device such as a flash drive.

14. The system of claim 1 wherein the coder's code, which is not accessible, does not comply with WCAG, and wherein the accessible version of the coder's code complies with WCAG, yielding an accessible WCAG compliant version of the coder's code.

15. The system of claim 1 wherein the software functionality addresses wrapped code within the coder's code.

16. The system of claim 1 wherein the software functionality modifies the coder's code by injecting additional code to the coder's code.

17. The system of claim 16 wherein said injecting takes place while the coder's code is being compiled.

18. The system of claim 16 wherein said injecting takes place as the coder's code transitions into production code.

19. A method for generating code, the method comprising:
providing software functionality, which, once integrated with coder's code, modifies the coder's code to yield an accessible version of the coder's code; and
providing an integration solution which integrates the software functionality with the coder's code.
